(19) United States
(12) Patent Application Publication
(10) Pub. No.: US 2007/0207691 A1
(43) Pub. Date: Sep. 6, 2007

(54) Needled three layered composite

(76) Inventors: Thomas Cobbett Wiles, Easley, SC (US); Kirkland W. Vogt, Simpsonville, SC (US)

Correspondence Address: Legal Department;Milliken & Company, (M-495), 920 Milliken Road, P.O. Box 1926, Spartanburg, SC, 29304, US

(21) Appl. No.: 11/367,195

(22) Filed: Mar. 3, 2006

(51) Int. Cl. B32B 5/26; D04B 1/22

(52) U.S. Cl. 442/318; 442/312; 442/319

(57) ABSTRACT

The invention relates to a needled composite comprising a double needle bar knit layer, a nonwoven layer, and a second knit layer, wherein each layer consists essentially of polyester and wherein the knit layers and the nonwoven layer are needled together and the process to form the needled composite.

### FIELD OF THE INVENTION

The invention generally relates to textile composites particularly useful in the formation of seating, door panels, and instrumentation panels in transportation vehicles. More specifically, the invention relates to textile composites which are useful as a replacement for the vinyl backing materials conventionally used in the manufacture of transportation vehicle seating, panels, and the like.

### BACKGROUND

Transportation vehicles such as cars, trucks, etc., typically have seats and panels which are covered with some form of durable material designed to withstand a variety of forces. The seats commonly include a platform (the part that the user contacts when he sits on the seat), the seat back (the part which faces the passenger sitting behind the seat), the skirt (the part which extends substantially vertically downward from the platform), and the sides, which connect all of the seat parts together. In most transportation vehicle seats, the primary emphasis is placed on the selection of the material for the platform, as this is the aesthetic focus of the seat within the vehicle. The interior of the vehicle also has side and frontal paneling which includes doors (panels for the front, rear, and hatch back rear door), instrumentation (including the dash board are from the passengers seat across to the drivers side), and rear cargo hold side facings

Common materials for the platform of such vehicle components include leather and cloth, such as woven fabrics, knit fabrics and the like. The remaining portions of the vehicle seats are collectively referred to herein as the seating trim. Such items of vehicle seating are typically made from vinyl material, even where natural leather has been used to form the seat platform.

Some considerations that vehicle component manufacturers must take into account when designing the fabrics are the particular physical parameters which must be achieved. A product currently in the market has three layers, a knit layer, a nonwoven layer, and a double needle bar knit layer. These three layers are adhesively adhered together. The results of this adhering process can cause the material to become stiff and less pliable, lose flexibility, have a loss of suppleness, and create a distorted appearance in the end use product

One alternative which the assignee of the instant invention has developed for use as a vinyl backing replacement material is a three layer needled composite fabric with a double needle bar knit layer, a nonwoven, and a second knit layer, all needled together.

### BRIEF DESCRIPTION OF THE DRAWINGS

An embodiment of the present invention will now be described by way of example, with reference to the accompanying drawings.

FIG. 1 is a cross-sectional view of a needled composite illustrating one embodiment of the invention.

### DETAILED DESCRIPTION

In the following detailed description of the invention, specific preferred embodiments of the invention are described to enable a full and complete understanding of the invention. It will be recognized that it is not intended to limit the invention to the particular preferred embodiment described, and although specific terms are employed in describing the invention, such terms are used in a descriptive sense for the purpose of illustration and not for the purpose of limitation.

The instant invention is directed to a fabric composite which can be used as a substitute for conventional vinyl trim materials. More specifically, the invention describes a composite which provides superior performance capabilities as compared with conventional vinyl trim materials, while also providing an enhanced aesthetic appearance. Furthermore, the composite of the instant invention is readily and efficiently recyclable, without the need for separation of the material inputs.

As will be recognized by those of ordinary skill in the art, products which are 95% polyester can be classified as 100% recyclable. However, additional processing is required during the recycling operation to separate the non-polyester component of the material being recycled. Therefore, this invention, consisting essentially of polyester, enables the ready recyclability of the needled composite without the added expense of the additional non-polyester component removal operation.

An additional feature required by most transportation vehicle seat covering materials is that they be flame retardant. To achieve this performance characteristic, manufacturers typically include a flame retardant within the polyurethane component of their seating and trim materials. However, the need for such flame retardants can be eliminated in the preferred embodiment of the composite of the instant invention, due to the self-extinguishing nature of the polyester used to form the components.

The composite of the invention is used as backing for vinyl to simulate leather. Typically, the composite is applied to door panels, instrumentation panels, and seating applications. The coating is typically applied to the non spacer side of the composite.

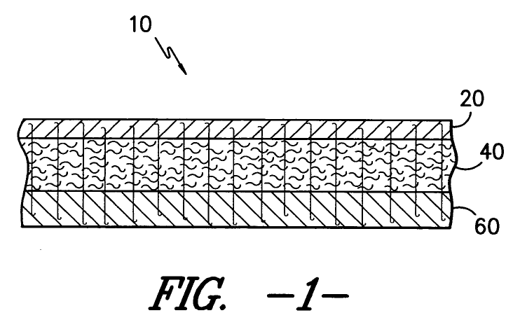

Referring now to FIG. 1, there is shown an enlarged, cross-sectional view of a needled composite 10. The needled composite 10 generally includes in order, a spacer fabric layer 60 and a nonwoven layer 40, and a second knit layer 20.

The spacer fabric layer 60 preferably comprises a double need bar knit layer consists essentially of polyester yarns and has outer bars and an inside bar. The outer bars of the double need bar knit have yarns with a denier of between 20 and 150 and the inside bar of the double need bar knit has yarns with a denier of between 20 and 200. Preferably, the outer bars and inside bar has a ply of between 1 and 2. The double needle bar knit fabric serves as a spacer fabric for the needled composite. “Spacer fabric” as defined in this application is a fabric that has upper and lower ground layers separated by a gap that is supported by spacing yarns or fibers. The spacer fabric provides unique properties to this composite that regular knit fabric do not provide. With the space provided by the supporting pile bars, the fabric is designed to have superior airflow permeability, provide a superior soft, supple feel to the touch, superior compression resistance, and superior recovery properties after compression has taken place.

In one embodiment, the double needle bar layer is produced on a Raschel warp knitting machine. Double needle bar Raschel warp knitting machines are basically equipped with two independently operated needle bars fed with multiple warps of yarn from a plurality of respective warp beams through a corresponding plurality of yarn guide bars. One common application of such knitting machines is to produce a so-called spacer or double plush pile fabric having two separate spaced-apart ground fabric structures integrated by one or more traversing yarns extending between and interknitted with the two ground structures. Spacer fabrics of this type are typically produced from three or more sets of warp yarns separately wound on individual warp beams and fed to the two needle bars through a corresponding set of yarn guide bars, normally with at least two sets of warp yarns fed through two corresponding guide bars exclusively to one of the needle bars to fabricate one ground structure, at least two other sets of warp yarns fed through other corresponding guide bars exclusively to the other needle bar to fabricate the other ground structure, and the remaining sets of warp yarns fed through one or more of the remaining available guide bars alternately to the two needle bars to extend between and interknit with the two ground structures and thereby to integrate and maintain the ground structures in spaced-apart essentially parallel relation.

Traditionally, double needle bar Raschel spacer fabrics of this type have been utilized as a means of producing two warp-knitted pile fabrics at once, the two ground structures of the spacer fabric being separated subsequent to knitting by a cutting operation wherein a cutting blade severs the traversing yarns intermediate the two ground structures leaving each ground structure with a plush pile surface produced by the outwardly extending portions of the severed yarns. More recently, however, attention has been directed to applications and uses of double needle bar Raschel spacer fabrics which are left intact as knitted without undergoing any cutting operation. Because the traversing pile yarns in such fabrics lend a three-dimensional quality to the fabrics and provide some degree of compressibility and resiliency across the thickness of the fabric, it has been proposed that such fabrics could be utilized as an acceptable substitute for conventional fabric-laminated foam materials such as neoprene and polyurethane.

The nonwoven layer 40 is formed from polyester fibers and has a density of about 1.0 oz/sq yd to about 20 oz/sq yd, and more preferably from 1.0 oz/sq yd to 15 oz/sq yd. The fibers of the nonwoven layer preferably have a denier of between 1 and 25. The nonwoven layer can be needle during processing or be airlayed.

The second knit layer 20 may be any known knit textile, including, but not limited to circular knit, warp knit, warp knit, weft-inserted warp knit, double needle bar, and jacquard knit fabrics. Flat knitted fabrics have been preferred in this application due to their ability to have varying but superior stretch qualities. In one embodiment, the second knit layer 20 is made with about 10 to about 50 wales per inch, and from about 10 to about 60 courses per inch. The second knit layer, in one embodiment, is composed of yarns with a denier of between 20 and 200 and is 1 or 2 ply.

In one embodiment, the double needle bar knit layer and the second knit layer are constructed using a filament polyester yarn of 20 to 150 denier weight, and the pile yarn is a 30 denier monofilament polyester. It has been found that the 30 denier monofilament polyester yarn provides a good compression resistance to the spacer fabric layer 60, which helps the double needle bar knit layer maintain the thickness property of the needled composite 10 during use of a molded car part, molded dash board, or seat formed from the needled composite 10. Additionally, it has been found that the monofilament polyester yarn is economical (as it is produced in high volume), provides an ease of fabrication, allows a lightweight and open (air-permeable) construction, has good colorability, and has inherent antimicrobial functionality (due to the hydrophobic nature of the polymer).

In the present invention, the composite is needled together without the use of any adhesives or glues. Needling the layers together is advantageous over the use of adhesives. Needling the layers together rather than using adhesives presents a better product for feel, suppleness, and moldability. Adhesive lamination has been the norm for combining multiple layers together for this end use application.

The needle composites are produced by needling, such that fibers or filaments are pulled out from the opposite surface with the assistance of barbs. The three layer composite may be needled together in a one or two step process. In the one step process, all three layers are laid out (in order, the double needle bar layer, the nonwoven layer, and the second knit layer) and then the three layers are needled together at once. In a two step process the nonwoven layer is first needled together with a first layer (either the double needle bar layer or the second knit layer) and then the two layers are needled together with the remaining layer.

In one embodiment, the needling of the three layer composite occurs from one side. This method is preferred when the needling of the composite does not need a high level of adhesion. In another embodiment, the needling of the three layer composite occurs from two sides. This method is preferred because it allows for maximum adhesion of all three layers in the composite.

In one embodiment, an elastomer may be applied to one or both sides of the needled composite. Preferably, the elastomer is applied in a liquid state as a water or solvent borne material. Preferably, the material is a waterborne dispersion. The resulting substrate can either be totally impregnated with elastomer, or the elastomer can only partially penetrate the composite, coating one or both surfaces. More preferably, gas will be incorporated into the waterborne dispersion to create a foam that can be coated onto the needled composite. Most preferably, the waterborne dispersion will be coagulable in the following inventive procedure: (a) producing an elastomer composition of at least four ingredients (an anionically-stabilized waterborne polymer dispersion, an acid-generating chemical, a cloud-point surfactant, and a foam-stabilizing surfactant); (b) incorporating sufficient gas into the liquid mixture to generate a spreadable foam; (c) applying the foam onto a porous textile substrate; (d) heating said foamed fabric until the elastomer coagulates over the fabric substrate; and (e) drying the resultant composite without destroying the coagulated structure. The resultant composite obtains a suppleness that is similar to that of leather and a surface that is suitable for transfer coating to produce artificial leather. This elastomer foam composition gives a fine-structured coagulum leather-like finish to fabrics which is comparable to, if not better than, leather-like finishes produced with organic solvent-borne systems (such as those described in U.S. Pat. No. 4,886,702). Thus, the inventive method and composition provide the means to produce, in a very safe manner, a fabric-elastomer composite having a desirable suppleness and appearance, which, when transfer or film-coated, effectively simulates a genuine leather article.

The term fabric-elastomer composite refers to an article comprised of a textile fabric, which has been coated on at least one side with an elastomer composition. As noted above, the inventive foamed elastomer composition comprises five materials: a waterborne polyurethane latex, an acid-generating chemical, a cloud-point surfactant, a foam-stabilizing surfactant, and sufficient gas that, when incorporated, produces the foamed product.

An anionically-stabilized polymer latex is an emulsion or dispersion formed from a polymer, an anionic surfactant, and water. Polyurethane, acrylic, or polyurethane-acrylic latex is preferable, but any waterborne anionically-stabilized polymer latex may be used. The preferred latexes are those having at least 30% solids content, with greater than 50% solids being more preferred. One preferred example of an anionically-stabilized polyurethane latex is EX-62-655 (40% solids), available from Stahl. A suitable anionically-stabilized polyurethane-acrylic latex is Paranol T-6330 (50% solids), available from Parachem. Examples of suitable anionic surfactants for use in the polymer dispersion include, but are not limited to, poly-acrylic acid copolymers, sodium laurel sulfate, aryl and alkyl benzene sulfonate like, but not limited to, the proprietary Rhodacal DS-10 (from Rhodia). In addition to the anionic surfactant and water, a nonionic surfactant may also be included in the polymer dispersion. Examples of a nonionic surfactant include polyvinyl alcohol and ethoxylated surfactants, such as Pluronic F-68 (from BASF). Also well known in the art is the incorporation of carboxyl or sulfate groups into the backbone of the polymer in order to help stabilize the latex. The waterborne criterion is of utmost importance within this invention primarily to insure that potentially environmentally harmful organic solvents are not present within the elastomer composition.

The term acid-generating compound denotes a chemical which is not an acid at room temperature, but which produces an acid upon exposure to a heat source. Examples include, but are not limited to, ammonium acid salts like ammonium sulfate, ammonium phosphate, and organic acid esters. One particularly suitable class of compounds that both meet this description and that provide superior results with little or no harmful environmental impact are organic acid esters. Some specific types of these compounds include ethylene glycol diacetate, ethylene glycol formate, diethylene glycol formate, triethyl citrate, monostearyl citrate, a proprietary organic acid ester available from High Point Chemical Corporation under the trade name Hipochem AG45, and the like. The most preferred compound is ethylene glycol diacetate, available from Applied Textile Technologies under the trade name APTEX™ Donor H-plus.

The term cloud-point surfactant is intended to encompass any surface-active agent that becomes less water soluble upon exposure to higher temperatures. This type of surfactant easily binds with the polymer latex upon gelling and facilitates the uniform coagulation of the latex over the entire contacted textile substrate. Specific surfactants that meet such requirements include poly(ethylene) oxides, poly(ethylene/propylene) oxides, polythio ethers, polyacetals, polyvinylalkyl ethers, organo-polysiloxanes, polyalkoxylated amines, or any derivatives of these listed compounds, with the preferred being polyalkoxylated amines, available from Clariant under the trade name Cartafix U™.

The term foam-stabilizing surfactant includes any surface-active agent that improves the ability of the inventive composition to entrain, and retain, air. Particular examples include, but are not limited to, alkyl benzene sulfates and sulfonates (Rexoprene series from Emkay Chemical) like sodium laurel sulfate (also sold under the name Stephanol AM from Stepan Corporation), sodium dioctyl sulfosuccinate, dodecyl benzene sulfonate, alkyl amine oxides (Unifroth series from Unichem Corp.), alkyl phosphates (Synfac series from Milliken Chemical), ammonium stearate (Henkel), water-soluble cellulose derivatives (Hercules Inc.), and Alkasurf DAP-9 (Rhodia). In the absence of a foam-stabilizing surfactant, gas could be introduced into the elastomer composition, but the gas would not be incorporated or retained.

The gas associated with the foam production is selected from the group consisting of atmospheric air, mixtures of oxygen, nitrogen, and hydrogen, and the like. Atmospheric air is preferred as an inexpensive and readily available source. The gas is incorporated at a pressure in the range of 1 pound per square inch (gauge) to 100 pounds per square inch (gauge), with a preferred range of about 25 p.s.i.g. to about 50 p.s.i.g. The acceptable weight ratio of air to latex within the composition is in the range of 0.1:1 to 50:1, with a preferred range of 3:1 to 8:1.

The air, or other gas, is incorporated into the foam by mechanical agitation. The air-incorporation process, commonly called foaming, may be accomplished through any accepted procedure. Examples, not intended as limitations, include whipping with a Hobart mixer or a Gaston Systems mechanical foamer. The foamed elastomer composition can then be applied with screen coating, knife coating, parabolic foam coating, and the like, without any limitation intended.

It has been found that incorporating air into (or foaming) the inventive composition offers several benefits over conventional application methods. First, the amount of elastomer applied to the textile substrate is less than the amount that would be used in a dip application, thus resulting in cost savings to manufacture. Secondly, because the incorporated air reduces the density of the inventive composition, the substrates that are produced following coagulation have aesthetic properties that more closely resemble leather. In addition, the air incorporated into the foam increases the volume of the coating, improving application and creating an improved surface for transfer coating. Finally, the manufacturer has greater control over the application of the elastomer. As a result, the foam mixture does not have to be applied to both sides of the fabric, as it would be with a dip application. Further, the degree of penetration of the foam into the textile substrate can also be controlled. Additional details on chemistry, process, and weight ratios may be found in U.S. Pat. No. 6,475,562, incorporated herein by reference.

### EXAMPLE

The Invention Example was a 3 layered needled composite formed from the following three layers:
1. Spacer Fabric Layer—Double Needle Bar Knit:
   a. Material: 100% polyester
   b. Yarn Denier: 30 and 70 denier yarns
   c. Density: Approximately 6.5 oz/sq
   d. Thickness: 1.5 to 2.5 mm thick
2. Nonwoven Layer—
   a. Material: 100% polyester
   b. Yarn Deniers: a mixture of 2 to 25 denier yarns
   c. Density: Approximately 6.0 oz/sq
3. Second Knit Layer—Circular Knit
   a. Material: 100% polyester
   b. Yarn Denier: 150 denier yarns
   c. Density: Approximately 4.0 oz/sq

The composite is combined by needling the top layer of circular knit to the middle layer of nonwoven. This composite is then needled to the bottom layer of double needle bar fabric. This composite was found to have good physical characteristics for vinyl backing replacement material and had flexibility.

This example illustrates the practice of this invention and is not intended to be exhaustive of all possible variations of the invention. The invention has been described in detail with particular reference to certain preferred embodiments thereof, but it will be understood that variations and modifications can be effected within the spirit and scope of the invention.

What is claimed is:

1. A needled composite comprising:
a first knit layer, wherein the first knit layer is a spacer fabric;
a nonwoven layer; and,
a second knit layer, wherein each layer consists essentially of polyester and wherein the knit layers and the nonwoven layer are needled together.

2. The needled composite of claim 1, wherein the spacer fabric is a double needle bar knit fabric.

3. The needled composite of claim 2, wherein the outer bars of the double need bar knit have a denier of between 20 and 150 and the inside bar of the double need bar knit has a denier of between 20 and 200.

4. The needled composite of claim 2, wherein the outer bars and the inside bar has a ply of between 1 and 2.

5. The needled composite of claim 1, wherein the nonwoven layer has a density of between 1 and 15 ounces per square yard.

6. The needled composite of claim 1, wherein the nonwoven layer has a denier of between 1 and 25.

7. The needled composite of claim 1, wherein the second knit layer is a circular or warp knit.

8. The needled composite of claim 1, wherein the second knit layer has a denier of between 40 and 200 and is 1 to 2 ply.

9. The needled composite of claim 1, wherein the needled composite is recyclable.

10. The needled composite of claim 1, wherein the needled composite contains no adhesive.

11. The needled composite of claim 1, wherein the needled composite comprises an elastomer coating on at least one side of the needled composite.

12. The needled composite of claim 1, wherein the needled composite comprises an elastomer foam coating on at least one side of the needled composite, wherein the elastomer foam coating comprises:
(i) a waterborne, anionically-stabilized polymer latex;
(ii) an acid-generating chemical;
(iii) at least one cloud-point surfactant; and
(iv) at least one foam-stabilizing surfactant; and
(v) sufficient gas to produce a foam when incorporated into said elastomer composition.

13. The needled composite of claim 12, wherein the elastomer foam is applied to one or both sides of the needled composite.

14. The needled composite of claim 12, wherein the weight ratio of (i) to (ii) is from about 10:1 to about 50:1; the weight ratio of (i) to (iii) is from about 10:1 to about 50:1; the weight ratio of (i) to (iv) is from about 10:1 to about 50:1; and the weight ratio of (i) to (v) is from about 3:1 to about 8:1.

15. A process for forming a needled composite comprising:
needling a first polyester knit layer to the first side of a polyester nonwoven layer;
needling a second polyester knit layer to the second of the polyester nonwoven layer.

16. The process of claim 15, wherein the needling occurs from one side

17. The process of claim 15, wherein the needling occurs from both sides.

18. A process for forming a needled composite comprising:
stacking in order, a first polyester knit layer, a polyester nonwoven layer, and a second polyester knit layer;
needling the layers together, wherein the needled composite consists essentially of polyester.

19. The process of claim 18, wherein the needling occurs from one side

20. The process of claim 18, wherein the needling occurs from both sides.
